(19) United States
(12) Patent Application Publication
(10) Pub. No.: US 2011/0016974 A1
(43) Pub. Date: Jan. 27, 2011

(54) APPARATUS AND METHOD FOR DETECTING DAMAGE TO A MACHINE

(75) Inventor: Stefan Wagner, Bad Honnef (DE)

Correspondence Address: BOYLE FREDRICKSON S.C., 840 North Plankinton Avenue, MILWAUKEE, WI, 53203, US

(73) Assignee: Wacker Neuson SE, Munich (DE)

(21) Appl. No.: 12/921,623

(22) PCT Filed: Apr. 17, 2009
(86) PCT No.: PCT/EP2009/002838

§ 371 Date: Sep. 9, 2010

(30) Foreign Application Priority Data
Apr. 18, 2008 (DE) 10 2008 019 578.2

(51) Int. Cl. G01N 29/04

(52) U.S. Cl. 73/579

(57) ABSTRACT

An apparatus for detecting damage to a machine that is excited at a previously known frequency by a vibration exciter, including an acceleration sensor for recording a current amplitude spectrum of an upper mass. A previously known amplitude spectrum of the upper mass is stored in a memory device. The current amplitude spectrum is compared with the previously known amplitude spectrum in a comparison device. If the comparison device determines that the spectra differ from one another, a corresponding deviation signal is generated and is output via a display device for informing the operator in order to inform the latter of possible damage.

### BACKGROUND OF THE INVENTION

1. Field of the Invention

The present invention relates to an apparatus and a method for detecting damage to a machine.

2. Description of the Related Art

Many machines, in particular construction equipment such as joint cutters, floor parting-off grinders, hammers, vibrating plates, vibrating rollers, tampers, etc., experience an excitation of their structure due to operating forces. Such machines often have drives that produce strong vibrations that then cause stress to the structure of the machine. In particular in vibrating machines such as vibrating plates and vibrating rollers or tampers, such vibrations are intended, and are part of the purpose of the machine. Due to the strength of the operating forces, which are mostly accompanied by vibration, after a certain operating time damage occurs to the structure that can cause significant further damage, or at least an undesired interruption of work operation. It is therefore desirable to detect damage to components that has already occurred during operation of the machine, and to inform the operator of such damage. Such timely error detection can prevent small initial errors or damage from leading to greater damage.

### SUMMARY OF THE INVENTION

Correspondingly, the object of the present invention is to indicate an apparatus and a method with which the beginning of damage to components can be detected and indicated to the user as early as possible.

According to the present invention, this object is achieved by an apparatus. for detecting damage to a machine excited by a vibration exciter with a previously known exciter frequency. The apparatus includes a detection device for acquiring at least one mechanical quantity for at least one component of the machine and for creating a current frequency spectrum on the basis of the acquired mechanical quantity, a storage device for storing a previously known frequency spectrum that was produced in advance for the previously known exciter frequency and, corresponding to the mechanical quantity, for the components of the machine, and a comparator device for comparing the current frequency spectrum with the previously known frequency spectrum, for determining a deviation that for example goes beyond a specified tolerance between the current frequency spectrum and the previously known frequency spectrum, and for producing a corresponding deviation signal.

The apparatus is correspondingly suitable for acquiring the frequency characteristic of at least one particular mechanical quantity and documenting it in the form of a current frequency spectrum. For this purpose, a suitable mechanical quantity for a component of the machine is selected. The component can be for example a single component, a group of a plurality of components, a structure, or a plurality of components coupled to one another rigidly or movably.

This component has a particular frequency characteristic in response to the previously known exciting vibration of the vibration exciter. This previously known response characteristic is stored in the storage device in the form of a previously known frequency spectrum. The previously known frequency spectrum can be determined for example by the manufacturer of the machine computationally or experimentally, and represents the response characteristic that is observed in the normal case of the relevant components for the exciting vibration generated by the vibration exciter.

The terms “frequency characteristic” or “frequency spectrum” can each refer to the amplitude spectrum. Alternatively, they may be understood to refer to the phase spectrum or to a combination of the amplitude spectrum and the phase spectrum. In this sense, the term “frequency spectrum” is a higher-order concept.

The frequency exciter can for example be a percussion mechanism in a hammer, a drive for a tamper for soil compaction, or a vibration exciter in a vibrating plate or roller, formed by one or more rotating unbalanced shafts. Due to the rotational speed of the drive, which is mostly constant during operation, the exciter or excitation frequency of the vibration exciter is also constant and corresponds to a previously known frequency.

Finally, the apparatus includes the comparator device with which the current frequency spectrum can be compared to the previously known frequency spectrum. If the comparator device determines that the two frequency spectra deviate from one another, this is taken as an indication that the frequency characteristics of the monitored components have changed. This in turn is evaluated as a sign that the structure of the components must have changed, which may be due in particular to damage to the components.

As mentioned above, the frequency spectrum may relate to the amplitude spectrum and/or to the phase spectrum. Correspondingly, in the evaluation of the frequency spectra described here it is possible to carry out the evaluation of amplitude spectra and phase spectra alternatively or so as to supplement one another. An evaluation of the phase spectrum in addition to the amplitude spectrum may be recommended from a technical point of view in order to permit a better and more robust detection of the resonant frequencies, or excessive increase in resonance.

For the analysis of the drive elements, such as the motor or a vibration exciter, their spectra and amplitude deviations, as well as relative shifts, are analyzed. This permits conclusions to be drawn concerning possible damage.

The deviation signal produced by the comparator device in this case can be supplied to a display device in order to output a signal, e.g. for the operator. The operator is then given the information that a change in structure of the machine has taken place that may be due to an error or damage. Depending on the design of the damage diagnosis apparatus, in this context the operator can be told concretely which component is probably damaged and which measures, e.g. repair measures, should be taken.

Alternatively or in addition, the evaluation results, in particular the deviation signal, can be communicated by radio to a central location. This central location, for example a computer at a construction site, can in this way receive, evaluate, store, and manage signals from a plurality of machines. In this way, at the central location it can be determined and documented whether a particular machine is fully functional or has already suffered damage.

Using the comparator, at least one resonant frequency can be identified in the current frequency spectrum and in the previously known frequency spectrum. In addition, the comparator device can compare the identified resonant frequency of the current frequency spectrum to the intensified resonant frequency of the previously known frequency spectrum in order to determine the deviation between the current frequency spectrum and the previously known frequency spectrum.

This means that is not necessary to continuously compare the full frequency spectra with each other. Rather, it is sufficient to monitor specific characteristic values, namely the relevant resonant frequencies. In doing this, it is monitored whether a resonant frequency that is previously known for a particular component changes during operation. Such a change in the resonant frequency during operation is evaluated as an indication that the structure of the relevant component has changed, which could permit inference of an error or damage.

Correspondingly, the resonant frequency can be defined in the form of an excess increase in resonance in the current frequency spectrum and in the previously known frequency spectrum. The excess increase in resonance and the amplitudes that are thus increased at certain frequencies make it possible to determine the resonant frequency relatively precisely in each case and to monitor its change if warranted.

The previously known frequency spectrum can be derived from the knowledge, in particular on the part of the manufacturer of the machine, as to which resonant frequencies correspond to which components. This knowledge can be determined in advance, e.g. by experimental or analytical modal analysis. In this way, it can be derived which component is affected by a change in characteristics when there is a change in the resonant frequency.

Mechanical components, or machines made of a plurality of components, have resonant frequencies that are typical for the mechanical system. The position of the resonant frequencies is characterized by the mechanical properties (mass distribution, damping properties, elastic properties). A rough distinction can be made between modal resonant frequencies (resonant oscillation forms that a component exhibits in itself when excited) and system resonant frequencies based on a mechanical coupling of a plurality of components. Lower resonant frequencies tend to characterize rigid-body movements, i.e. resonant frequencies based on the coupling of components that are coupled via spring/damper elements, whereas higher resonant frequencies can be attributed to the structural modes of the components.

In a machine, due to the nature of the process alternating forces act with a high amplitude. Correspondingly, even given excitation with an almost constant frequency, e.g. by a vibration exciter, the entire frequency spectrum is excited. Using the damage diagnosis apparatus, it is possible to measure a typical mechanical quantity, e.g. an acceleration, at a suitable point, and to read out the resonant frequencies from the amplitude spectrum through the corresponding excess increases in resonance in the range of these resonant frequencies.

The resonant frequency to be identified by the comparator device can be specified in advance if the manufacturer of the machine has knowledge of the characteristic resonant frequencies of the components that are to be monitored. This resonant frequency can correspondingly be assigned to a particular component of the machine.

The comparator device can be used not only to detect a change in the resonant frequency, but also to determine whether the resonant frequency of the current frequency spectrum has become higher or lower relative to the specified resonant frequency of the previously known frequency spectrum. From the direction of shift of the resonant frequencies, i.e. whether the resonant frequencies have become higher or lower, information can be derived as to the type of change in property.

Of course, the comparator device can also be used to monitor a plurality of specified resonant frequencies.

It is also possible for the plurality of specified resonant frequencies to be assigned to respective components of the machine or properties of at least one component. This means that the damage diagnosis apparatus can monitor a plurality of components, or can also monitor a plurality of properties (resonant frequencies) of a particular component.

The mechanical quantity can be a quantity that is accompanied by vibration, in particular an acceleration, a speed, a path, or a relative position. In addition, the mechanical quantity can be an absolute quantity relative to an absolute reference system, such as the earth's coordinate system, or a relative quantity in the form of a relative behavior between two or more components of the machine. Thus, it is for example possible to determine the vibration characteristic of a component relative to the surrounding environment (absolute coordinate system). The vibration or movement characteristic of two components relative to one another can also be monitored.

If the mechanical quantity is an acceleration, it can be useful for the detection device to have an acceleration sensor.

The frequency spectrum can for example be represented by an amplitude spectrum that characterizes the vibration behavior of a component. The frequency spectrum can therefore correspond to an amplitude spectrum of at least that component on which a corresponding sensor of the detection device is provided. The amplitude spectrum represents the response characteristic of the component due to the exciting vibration.

Correspondingly, the amplitude spectrum can be produced on the basis of an acceleration signal originating from the acceleration sensor.

Alternatively or in addition to the amplitude spectrum, the frequency spectrum can also be represented by a phase spectrum, or a combination of phase spectrum and amplitude spectrum, in order to characterize in the vibration behavior of a component. In this way, the excess increases in resonance, or resonant frequencies, can be reliably detected.

The detection device can have a plurality of sensors that are situated at various locations on the machine and/or at various locations on a component of the machine. In this way, the detection device, and thus the damage diagnosis apparatus as a whole, can monitor all essential components of the machine. A person skilled in the art can easily identify suitable locations in the machine that are particularly useful for monitoring.

As already stated, the sensor can be an acceleration sensor. Other sensors may include a path sensor, an acoustic sensor, a microphone, an expansion sensor, or an expansion measurement strip sensor. Optical, capacitive, or inductive sensors are also possible, with which for example relative movements between individual components can be detected.

The display device can produce an acoustic and/or optical signal in order to inform the operator of a case of damage, or at least of a change in the vibration characteristics of the monitored component. Depending on the complexity of the device, the operator may also be given a proposed counter measure. If, for example, the damage diagnosis apparatus determines that a rubber cushion in a vibrating plate exhibits a change in its properties that could be due to damage, e.g. crack formation, a recommendation can be made to the operator to exchange the relevant rubber cushion. For this purpose, the display device could in addition provide precise information concerning which of the (for example) four rubber cushions of the vibrating plate are to be exchanged.

A method for detecting damage to a machine excited by a vibration exciter with a previously known exciter frequency has the following steps:
acquisition of at least one mechanical quantity accompanied by vibration for at least one component of the machine;
creation of a current frequency spectrum based on the acquired mechanical quantity;
comparison of the current frequency spectrum to a previously known frequency spectrum that was determined and stored in advance; and
production of a signal if the comparison determines a deviation, for example exceeding a specified tolerance, between the current frequency spectrum and the previously known frequency spectrum.

It is not necessary that a frequency spectrum be compared in its entirety. In some circumstances, it can be sufficient if only partial areas of the frequency spectra are compared to one another.

It can be useful not to take into account the frequencies of the exciting forces, for example the unbalanced forces of a vibration exciter, and their harmonics, in the recognition of structural damage.

The comparison of a current frequency spectrum to a previously known frequency spectrum can also be carried out by determining the excess increases in resonance relative to one another within a frequency spectrum and subsequently comparing them to those of the comparison frequency spectrum. Conclusions concerning damage in the structure can then be drawn via the deviations in the excess increases in resonance.

These and additional advantages and features of the present invention are explained in the following on the basis of an example, with the aid of the accompanying Figures.

### BRIEF DESCRIPTION OF THE DRAWINGS

FIG. 1 shows a schematic side view of a vibrating plate having an acceleration sensor;

FIG. 2 shows a schematic design of a damage diagnosis apparatus; and

FIG. 3 shows an example of an amplitude spectrum detected by an acceleration sensor.

### DETAILED DESCRIPTION OF THE PREFERRED EMBODIMENTS

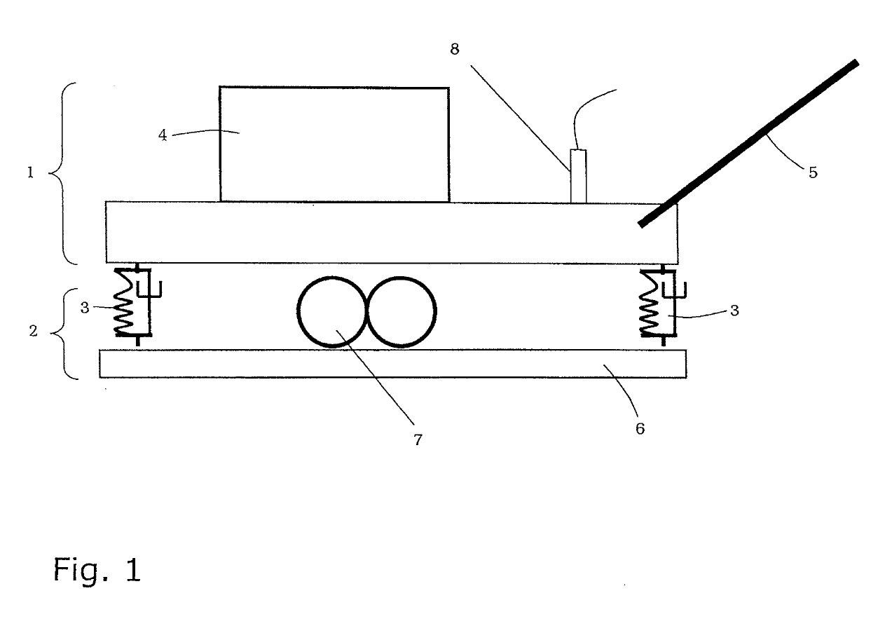

FIG. 1 shows a machine in the form of a construction machine, in this case a vibrating plate. The apparatus according to the present invention can however be used in many other types of machines, including construction machines, in order to enable timely diagnosis of damage to mechanical components.

The vibrating plate has an upper mass 1 that is coupled via spring damper elements 3 to a lower mass 2 so that the two are movable relative to one another. Upper mass 1 includes, inter alia, a drive motor 4 and a drawbar 5 via which an operator can manually guide the vibrating plate. Lower mass 2 has a soil contact plate 6 for compacting the soil and a vibration exciter 7 that impacts soil contact plate 6 and that is driven by drive motor 4. Vibration exciter 7 can be made up for example of two unbalanced shafts that rotate in opposite directions with a positive fit and that produce a directed vibration. However, other possibilities for vibration excitation are also known.

In many vibrating plates, spring-damper elements 3 are formed by rubber cushions that connect upper mass 1 to lower mass 2. Such rubber cushions are especially susceptible to a high degree of wear, and have a tendency to form cracks, with subsequent rapid destruction.

Such a vibrating plate is known in many specific embodiments. Thus, there are also vibrating plates that do not have a drawbar 5 for manual guidance, but rather are equipped with a remote control unit.

In the vibrating plate according to the present invention, on the upper mass there is provided an acceleration sensor 8 that acquires the accelerations acting on upper mass 1 and correspondingly produces an acceleration signal 9 during operation of the vibrating plate.

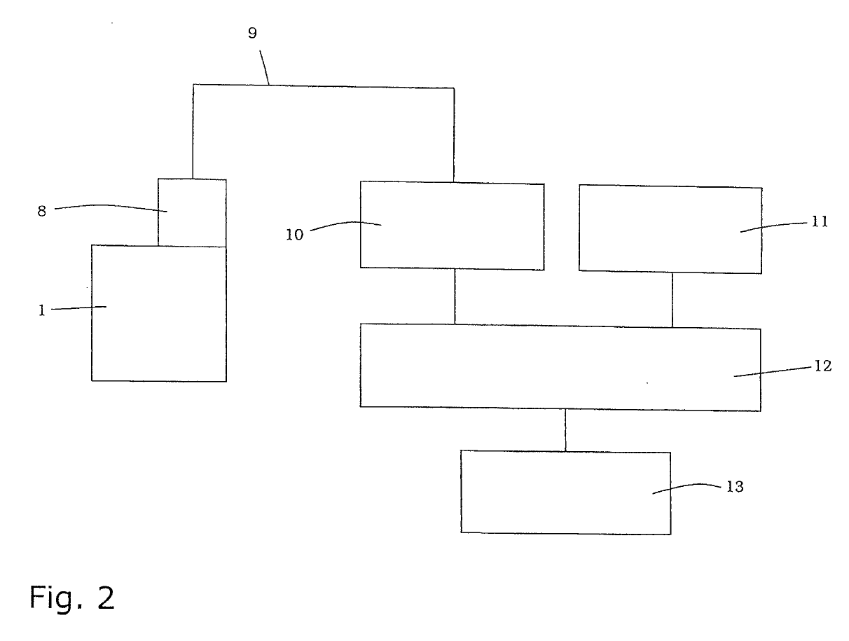

FIG. 2 shows a schematic design of the damage diagnosis apparatus.

Upper mass 1 and acceleration sensor 8 are also shown in FIG. 2. Acceleration signal 9 generated by acceleration sensor 8 is supplied to a detection device 10 that stores acceleration signal 9 using suitable data transmission and recording methods. Acceleration sensor 8, and the line for acceleration signal 9, are regarded as part of detection device 10. On this basis, detection device 10 generates a current frequency spectrum or amplitude spectrum.

In addition, a storage device 11 is provided in which a previously known frequency spectrum or amplitude spectrum for upper mass 1 is stored. This amplitude spectrum was previously determined experimentally or computationally, e.g. at the manufacturer. It is not absolutely necessary to store the entire amplitude spectrum. Rather, it can be sufficient to store only characteristic values, namely in particular resonant frequencies and corresponding excess increases in resonance.

Detection device 10 and storage device 11 are coupled to a comparator device 12 in which the frequency spectra from detection device 10 and from storage device 11 are compared. If only characteristic values (resonant frequencies) are to be compared, the comparator apparatus can be correspondingly designed.

If comparator apparatus 12 determines that the actual frequency spectrum (or individual resonant frequencies) measured by detection device 10 deviates from the previously known frequency spectrum stored in storage apparatus 11, a corresponding item of information can be outputted to the operator via a display device 13.

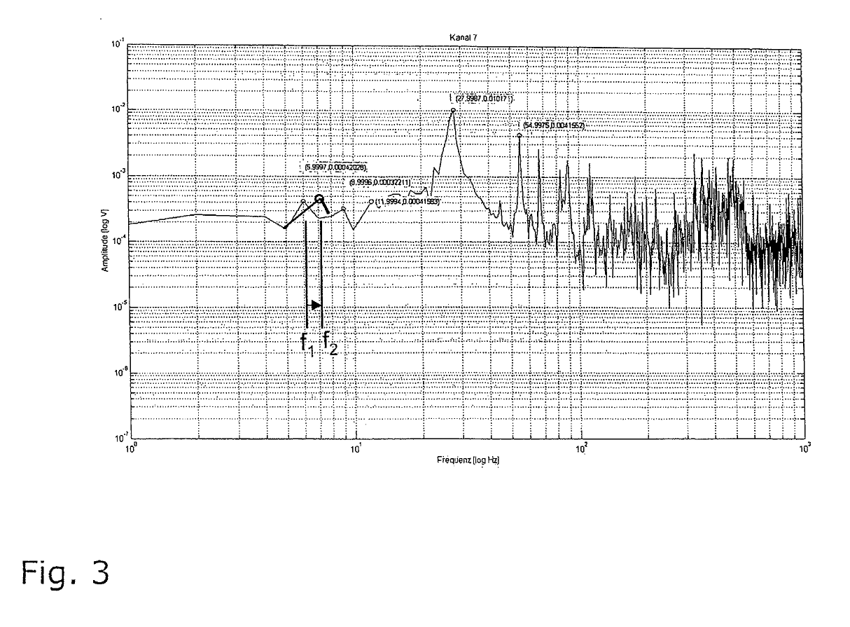

FIG. 3 shows, as an example, the amplitude spectrum of an acceleration signal 9 determined by acceleration sensor 8 on upper mass 1 of the vibrating plate during a compaction process.

In the amplitude spectrum, a resonant frequency f₁ at a frequency of approximately 6 Hz has been labeled. Other excess increases in resonance that are not labeled can be read at 9 Hz, 12 Hz, 28 Hz, and 55 Hz. In addition, further higher-frequency excess increases in resonance also result.

Resonant frequency f₁ characterizes a natural mode at which upper mass 1 vibrates relative to lower mass 2. If there now occurs an increase in the rigidity of the cushions, for example due to irreversible joint deformation resulting for example from heating and cooling processes in the elastic cushions of spring-damper elements 3, resonant frequency f₁ will shift to a resonant frequency f₂, as is identified by lines drawn in FIG. 3.

Correspondingly, resonant frequency f₁ can also shift downward to lower resonant frequencies, if for example the cushions in spring-damper elements 3 become softer due to cracks.

When there is a shift in the resonant frequency, and a change in property detected thereby, the operator of the machine can be informed of this error, for example by an acoustic or optical signal via display device 13. In addition, given a corresponding evaluation of the change in property, the type of error or type of change in property can also be displayed.

The information concerning the error or damage can also be stored in display device 13 and not displayed or outputted until later, e.g. during a regularly scheduled inspection.

Of course, alternatively or in addition to acceleration sensor 8 it is also possible to use a plurality of measurement value sensors in order to increase the quality of diagnosis.

Shifts in higher-frequency maxima (excess increases in resonance) provide information concerning changes in the natural modes the components to which the sensor is attached. They thus indicate cracks or changes in the structure.

A problem that often occurs in vibrating plates is for example cracks in the protective frame of upper mass 1, which in this way can be detected early in order to prevent further damage. Thus, given early detection such cracks can for example be sealed by a weld seam without requiring more expensive restoration measures.

Lower resonant frequencies, in contrast, are signs of rigid body movements, i.e. resonant frequencies due to the coupling of components that are coupled via spring-damper elements. Thus, changes in such lower resonant frequencies indicate that the spring-damper elements have been damaged, because the coupled masses (e.g. upper mass 1 and lower mass 2) do not change during operation.

Instead of acceleration sensor 8, other sensors or measurement methods may also be used to determine or measure the characteristic amplitude spectrum of the structure or component assembly that acquire, immediately or immediately, the effect of mechanical movements and accelerations. These include for example microphones, DMS sensors, path sensors, etc.

1. An apparatus for detecting damage to a machine excited with a previously known exciter frequency by a vibration exciter, comprising:
a detection device for acquiring at least one mechanical quantity for at least one component of the machine and for producing a current frequency spectrum on the basis of the acquired mechanical quantity;
a storage device for storing a previously known frequency spectrum that was produced in advance for the previously known exciter frequency and that corresponds to the mechanical quantity for the component of the machine; and
a comparator device for comparing the current frequency spectrum to the previously known frequency spectrum, determining a deviation between the current frequency spectrum and the previously known frequency spectrum, and producing a corresponding deviation signal.

2. The apparatus as recited in claim 1, further comprising a display device for outputting a signal when the deviation signal is produced by the comparator device.

3. The apparatus as recited in claim 1, wherein the component of the machine is a single component, a structure, or a plurality of components connected to one another rigidly or movably.

4. The apparatus as recited in claim 1, wherein
at least one resonant frequency in the current frequency spectrum and in the previously known frequency spectrum is identifiable using the comparator device; and
the identified resonant frequency of the current frequency spectrum can be compared with the identified resonant frequency of the previously known frequency spectrum using the comparator device, in order to determine the deviation between the current frequency spectrum and the previously known frequency spectrum.

5. The apparatus as recited in claim 1, wherein the resonant frequency is definable in the form of an excess increase in resonance in the current frequency spectrum and in the previously known frequency spectrum.

6. The apparatus as recited in claim 1, wherein
the resonant frequency that is to be identified by the comparator device is prespecified; and
this resonant frequency can be assigned to a particular component of the machine.

7. The apparatus as recited in claim 1, wherein, using the comparator device, it is possible to determine whether the resonant frequency of the current frequency spectrum has become higher or lower relative to the prespecified resonant frequency of the previously known frequency spectrum.

8. The apparatus as recited in claim 1, wherein, using the comparator device, it is possible to monitor each of a plurality of specified resonant frequencies.

9. The apparatus as recited in claim 1, wherein the plurality of specified resonant frequencies are each assigned to respective components of the machine or to properties of at least one component.

10. The apparatus as recited in claim 1, wherein the mechanical quantity is a quantity that is accompanied by vibration and comprises at least one of an acceleration, a speed, a path, and a relative position.

11. The apparatus as recited in claim 1, wherein the mechanical quantity is an absolute quantity relative to an absolute reference system or is a relative quantity in the form of a relative behavior between two or more components of the machine.

12. The apparatus as recited in claim 1, wherein the mechanical quantity is an acceleration, and wherein the detection device has an acceleration sensor.

13. The apparatus as recited in claim 1, wherein the frequency spectrum is at least one of an amplitude spectrum and a phase spectrum of at least one component on which a sensor of the detection device is provided.

14. The apparatus as recited in claim 1, wherein the frequency spectrum is at least one of an amplitude spectrum and/or a phase spectrum of an acceleration signal produced by the acceleration sensor.

15. The apparatus as recited in claim 1, wherein the detection device has a plurality of sensors that are situated at various locations of the machine and/or at various locations of a component of the machine.

16. The apparatus as recited in claim 15, wherein the sensor is at least one of an acceleration sensor, a path sensor, an acoustic sensor, a microphone, an expansion sensor, and an expansion measurement strip sensor.

17. The apparatus as recited in claim 1, wherein, using the display device, it is possible to produce at least one of an acoustic and an optical signal in order to inform the operator of a case of damage.

18. A method for detecting damage to a machine excited with a previously known frequency by a vibration exciter comprising:
acquiring at least one mechanical quantity that is accompanied by vibration for at least one component of the machine;
creating a current frequency spectrum on the basis of the acquired mechanical quantity;
comparing the current frequency spectrum to a previously known frequency spectrum that was determined and stored in advance; and
producing a signal if the comparison determines that there is a deviation between the current frequency spectrum and the previously known frequency spectrum.

19. An apparatus for detecting damage to a machine excited with a previously known frequency by a vibration exciter, the apparatus comprising:
means for acquiring at least one mechanical quantity that is accompanied by vibration for at least one component of the machine;
means for creating a current frequency spectrum on the basis of the acquired mechanical quantity;
means for comparing the current frequency spectrum to a previously known frequency spectrum that was determined and stored in advance; and
means producing a signal if the comparison determines that there is a deviation between the current frequency spectrum and the previously known frequency spectrum.
